(19) United States
(12) Patent Application Publication
(10) Pub. No.: US 2026/0236408 A1
(43) Pub. Date: Aug. 13, 2026

(54) DEBUG CIRCUIT AND PROCESSOR INCLUDING THE SAME

(71) Applicant: Samsung Electronics Co., Ltd., Suwon-si (KR)

(72) Inventors: Jaehwan Jung, Suwon-si (KR); Hee Hyun Nam, Suwon-si (KR); Dongmin Lee, Suwon-si (KR); Ranhee Lee, Suwon-si (KR); Youngseob Choi, Suwon-si (KR)

(21) Appl. No.: 19/316,147

(22) Filed: Sep. 2, 2025

(30) Foreign Application Priority Data
Feb. 11, 2025 (KR) 10-2025-0017501

(51) Int. Cl. G06F 13/16; G06F 11/362

(52) U.S. Cl. CPC G06F 13/1673; G06F 11/3644

(57) ABSTRACT

A processor includes: a core, a register, and a debug circuit. The core is configured to store status data indicating the status of the core. The debug circuit is configured to receive a debugging request signal, determine a subject to perform a debugging operation based on the debugging request signal, and output a debug mode entry signal to the subject.

### CROSS-REFERENCE TO RELATED APPLICATION

This application claims priority to and the benefit of Korean Patent Application No. 10-2025-0017501 filed with the Korean Patent Office on Feb. 11, 2025, the entire contents of which are incorporated herein by reference.

### BACKGROUND

Debug circuits may be used in a variety of scenarios to detect and correct problems in the processor. By using the debug circuitry within the processor together with an external debugger, it may be easy to identify the cause of problems that occur during the operation of the processor. It may be used for activities such as design verification, software problem assessment, etc.

### SUMMARY

In some examples, the debug circuit may perform debugging operations using cores within the processor. For example, a core performing an action according to a user program may halt the action being performed and perform a debugging action. However, in a core hang situation due to various causes, the core has a problem in that it cannot perform normal debugging operations.

The present disclosure is to provide a debug circuit that performs a debugging operation in a core row situation and a processor including the same.

In general, in some aspects, the present disclosure provides a processor that includes: a core, a register configured to store status data indicating the status of the core, and a debug circuit configured to receive a debugging request signal, determine a subject to perform a debugging operation based on the debugging request signal, and output a debug mode entry signal to the subject.

In general, in some aspects, the present disclosure provides an operating method of processor, the method including: receiving a debugging request signal instructing to investigate the status of first core; checking the operating status of the first core, and instructing the first core or second core to perform debugging operation based on the operating state of the first core.

In general, in some aspects, the present disclosure provides a system on chip that includes: memory, a processor including core configured to process data stored in the memory, and a debug circuit configured to halt operation of the core based on a debugging request signal, determine operating state of the core based on state of program counter of the processor, and perform a debugging operation according to a debug code based on the operating state of the core.

### BRIEF DESCRIPTION OF THE DRAWINGS

FIG. 1 is a block diagram illustrating an example of a debugging system.

FIG. 2 is a schematic block diagram of an example of a debug circuit.

FIG. 3 is a flowchart of an example operation method of a debug circuit.

FIG. 4 is a diagram illustrating an example operation of a debugging system.

FIG. 5 is a flowchart of an example operation method of a debug circuit.

FIG. 6 is a flowchart of an example operation method of a debug circuit.

FIG. 7 is a block diagram illustrating an example of a debugging system.

FIG. 8 is a block diagram illustrating a configuration of an example of a system on chip.

FIG. 9 is a diagram illustrating an example of an electronic system.

### DETAILED DESCRIPTION

Below, with reference to the attached drawings, some implementations of the present invention is described in detail so that a person having ordinary skill in the art to which the present invention pertains may easily practice the present invention. However, the present invention may be implemented in various different forms and is not limited to the implementations described herein.

And in order to clearly explain the present invention in the drawings, parts that are not related to the explanation are omitted, and similar parts are given similar drawing reference numerals throughout the specification. In the flowchart described with reference to the drawings, the order of operations may be changed, several operations may be merged, some operations may be split, and certain operations may not be performed.

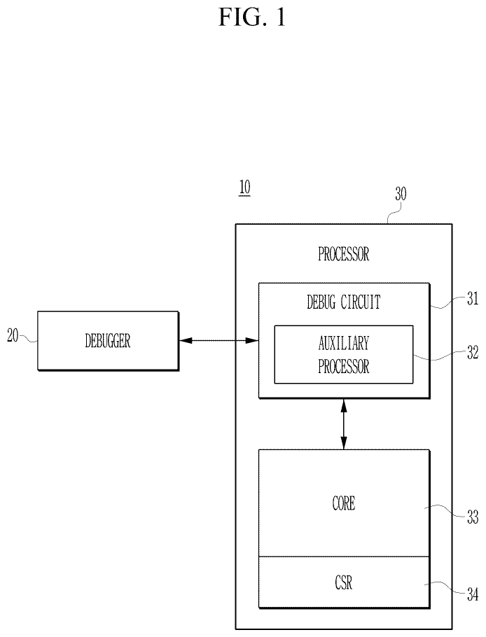

FIG. 1 is a block diagram illustrating a debugging system according to some implementations.

In some implementations, the debugging system 10 may include a debugger 20 and a processor 30. Here, the debugger 20 may refer to, but is not limited to, debugging software for a software programmer running on a host processor (e.g., a laptop computer, etc.). A user of the debugging system 10 may interact with a host processor running a debugger 20.

In some implementations, the processor 30 may be a central processing unit. The processor 30 may control and process the overall operation of the debugging system 10.

In some implementations, the processor 30 may include a debug circuit 31 and a core 33. Here, the processor 30 is illustrated as including one core 33, but is not limited thereto. For example, the processor 30 may be a multi-core processor including two or more cores. In some implementations, the core 33 may process a plurality of instructions and data that constitute software. For example, the core 33 may fetch the plurality of instructions or data, process the fetched instructions or data, and store them in an internal register (e.g., a control status register). In some implementations, the core 33 may process the plurality of instructions and data according to a user program (e.g., general code), and may process the plurality of instructions and data according to debug code in a debug mode.

In some implementations, the debug circuit 31 may receive a debugging request signal from the debugger 20. For example, the debug circuit 31 may interface with the debugger 20 according to various communication standards such as JTAG Joint Test Action Group (JTAG), compact JTAG (cJTAG), and Serial Wire Debug (SWD). However, it is not limited thereto, and the debug circuit 31 may interface with the debugger 20 according to various communication standards. The debug circuit 31 may receive a debugging request signal from the debugger 20 and instruct the processor 30 to process a plurality of instructions and data according to the debug code. The debug circuit 31 may output the processing results of the plurality of commands and data according to the debug code to the debugger 20.

The debug circuit 31 may instruct the core 33 to enter debug mode so that the core 33 may perform a debugging operation at the request of the debugger 20. Specifically, the debug circuit 31 may output a debug mode entry signal to the core 33 based on a request from the debugger 20. Based on the debug mode entry signal, the core 33 may perform debugging operations. For example, the debug circuit 31 may output a debug mode entry signal to the core 33 to halt the operation of the core 33 and cause the core 33 to execute debugging operations according to the debug code.

In some implementations, the debug circuit 31 may include an auxiliary processor 32. The auxiliary processor 32 may be a CPU. The auxiliary processor 32 may be implemented in a relatively smaller size than the processor 30. The auxiliary processor 32 may be a single core processor including one core or a multi-core processor including two or more cores. The auxiliary processor 32 may use relatively low power compared to the processor 30 and may be implemented to perform a designated function. The auxiliary processor 32 may be implemented to execute a small number of simple instructions. For example, the auxiliary processor 32 may be implemented to process a plurality of instructions and data corresponding to debug code in debug mode. Hereinafter, an operation of processing the plurality of commands and data corresponding to debug code may be referred to as a debugging operation. The auxiliary processor 32 may be implemented separately from the processor 30 or as part of it.

In some implementations, the debug circuit 31 may instruct the auxiliary processor 32 within the debug circuit 31 to enter a debug mode so that the auxiliary processor 32 performs a debugging operation according to the request of the debugger 20. Specifically, the debug circuit 31 may output a debug mode entry signal to the auxiliary processor 32 based on a request from the debugger 20. Based on the debug mode entry signal, the auxiliary processor 32 may perform debugging operations. For example, the debug circuit 31 may halt the operation of the core 33 and output a debug mode entry signal to the auxiliary processor 32 so that the auxiliary processor 32 executes a debugging operation according to the debug code. Alternatively, the debug circuit 31 may output a debug mode entry signal to the auxiliary processor 32 so that, when the core 33 malfunctions, the operation of the core 33 is halted and the auxiliary processor 32 performs a debugging operation according to the debug code.

In some implementations, the processor 30 may further include a control state register CSR 34. The control status register 34 is a special register that may control the processor 30 and may store and manage status data indicating the status of the processor 30. For example, when an interrupt occurs during the operation of the processor 30, the processor 30 may store the cause of the interrupt, information on the address to which the processor 30 will return, etc., in the control status register 34.

In some implementations, the processor 30 may perform debugging operations according to the request of the debugger 20. As an example of a debugging operation, the processor 30 may perform an operation to investigate the status of the core 33. Specifically, the debug circuit 31 may output a debug mode entry signal to the auxiliary processor 32 or the core 33 based on a request from the debugger 20, and the auxiliary processor 32 or the core 33 may access the control status register 34 to collect status information of the processor 30. For example, depending on the debug code, the auxiliary processor 32 or core 33 may access the control status register 34 and collect or process status data stored in the control status register 34. In some implementations, the debug circuit 31 may transfer data obtained from the control status register 34 by the auxiliary processor 32 or core 33 to the debugger 20 as a debug result.

Here, the debug circuit 31 is illustrated as being included in the processor 30, but is not limited thereto. For example, the debug circuit 31 may be configured separately from the processor 30.

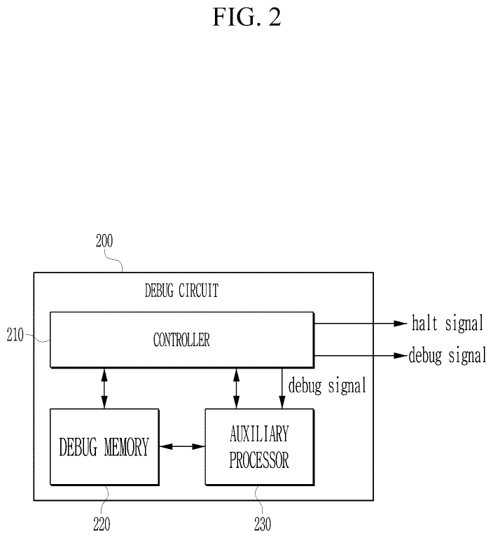

FIG. 2 is a schematic block diagram of a debug circuit according to some implementations.

Referring to FIG. 2, the debug circuit 200 may include a controller 210, debug memory 220, and an auxiliary processor 230.

In some implementations, the controller 210 may control the overall operation of the debug circuit 200. For example, when the controller 210 receives a debug request signal from the debugger 20 of FIG. 1, controller 210 may output a halt signal to halt the operation of the core (33 of FIG. 1). Based on this, the core 33 may halt execution of a user program (e.g., general code). The controller 210 may output a halt signal to halt the operation of the core 33, and then output a debug mode entry signal (debug signal) to the core 33 or auxiliary processor 230 to instruct it to enter a debug mode.

In some implementations, the debug circuit 200 may include debug memory 220. The debug memory 220 may store debug code to be executed by the processor (30 of FIG. 1) in debug mode. The debug memory 220 may store routine debug codes that are executed in debug mode. For example, debug code stored in the debug memory 220 may include initialization code that the processor 30 may execute immediately upon entering debug mode, memory and/or register access code that instructs the processor 30 to access a specific memory address and/or register, single step code for tracing the flow of code, etc. The debugger 20 may store debug code to be performed by the processor 30 in debug mode in the debug memory 220. For example, the debugger 20 may store code in the debug memory 220 that instructs the processor 30 to check or modify the internal state of the processor 30. The debug memory 220 may be implemented as a volatile memory device such as SRAM (static random access memory), but is not limited thereto.

In some implementations, the auxiliary processor 230 may receive a debug mode entry signal from the controller 210 and perform a debugging operation. Specifically, the auxiliary processor 230 may receive a debug mode entry signal from the controller 210 and perform a debugging operation according to the debug code stored in the debug memory 220. The auxiliary processor 230 may fetch the plurality of instructions or data stored in the debug memory 220 and process the fetched instructions or data.

In some implementations, the auxiliary processor 230 may access a specific memory address or register according to debug code stored in the debug memory 220 and store data at that address or read data stored at that address. The auxiliary processor 230 may investigate the status of the core 33 according to the debug code stored in the debug memory 220. For example, the auxiliary processor 230 may access a control status register (34 of FIG. 1) within the processor 30 according to a debug code stored in the debug memory 220, and read status data stored in the register or process the status data stored in the register.

In some implementations, the auxiliary processor 230 may store the results of execution of the debug code in a buffer (not shown) or a control status register 34 within the debug circuit 200. The controller 210 may transmit data stored in a buffer (not shown) or a control status register 34 to the debugger 20 as a debug result.

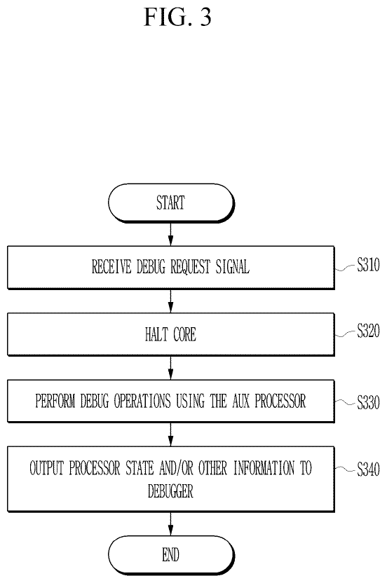

FIG. 3 is a flowchart showing an operation method of a debug circuit according to some implementations.

In some implementations, the debug circuit may receive a debug request signal from a debugger S310. The debugger may output debug request signals at regular intervals or to check the state of the processor.

In some implementations, the debug circuit may halt the operation of the core S320. Specifically, the debug circuit may output halt signal to the core based on a debug request signal, so that the core halts the currently executing program. The core may halt the currently running program and store information about the program that was running just before the halt in internal registers. After the debugging operation is complete, the core may resume execution of the program from the point where it was halted based on information stored in internal registers.

In some implementations, the debug circuit may perform debugging operations using an auxiliary processor S330. Specifically, the debug circuit may output a debug mode entry signal that instructs the auxiliary processor within the debug circuit to enter a debug mode, and perform a debugging operation using the auxiliary processor. The auxiliary processor may perform debugging operations based on debug code stored in debug memory. For example, the auxiliary processor may access the control status registers to examine the core's state.

In some implementations, the debug circuit may output processor status and/or other information to the debugger S340. Specifically, the auxiliary processor may obtain processor status data or data stored in other memories according to the debug code. The auxiliary processor may store data acquired during debugging operations in control status registers within the processor or in buffers within the debug circuitry. The debug circuit may output data stored in the control status register or a buffer within the debug circuit to the debugger.

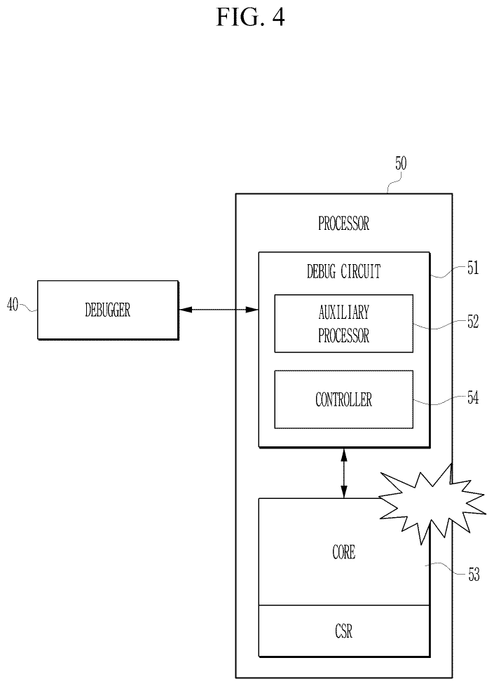

FIG. 4 is a diagram for explaining the operation of a debugging system according to some implementations. Here, any explanation that is identical or similar to the above explanation is omitted.

In some implementations, the debugger 40 may output a debug request signal to the debug circuit 51, and the debug circuit 51 may instruct the processor 50 to perform a debugging operation. In some implementations, the debug circuit 51 may direct a core 53 or a coprocessor 52 within the processor 50 to perform a debugging operation. In some implementations, the debug circuit 51 may determine which entity will perform the debugging operation based on the state of the core 53.

The core 53 may malfunction during operation due to various causes. For example, the core 53 may malfunction due to incorrect condition processing at the pipeline stage or various bugs in the process of processing the plurality of instructions and data according to a user program. Alternatively, the core 53 may halt for various reasons during the process of processing the plurality of instructions and data according to the user program (i.e., a core hang situation may occur). The debug circuit 51 may output a debug mode entry signal to the core 53. However, a problem may occur in which the core 53 cannot perform a debugging operation according to a debug mode entry signal due to a malfunction of the core 53 or a core hang situation. Alternatively, when resetting the core 53 to resolve a malfunction or core hang situation of the core 53, the status information of the core 53 is also reset (or changed), so there is a problem in that the status information of the core 53 in the case of a malfunction or core hang situation cannot be confirmed.

In some implementations, the debug circuit 51 may include an auxiliary processor 52 and a controller 54. The controller 54 may check whether the core 53 is malfunctioning. For example, the controller 54 may check whether the core 53 is malfunctioning based on the status of a program counter that stores the address of the instruction to be executed by the core 53 within the processor 50. Specifically, the controller 54 may determine that the core 53 is malfunctioning or in a core hang situation if the value of the program counter within the processor 50 does not increase for a predetermined period of time. However, the method by which the controller 54 checks whether the core 53 is malfunctioning is not limited to this. In some implementations, the controller 54 may check whether the core 53 is malfunctioning and determine that the core 53 is malfunctioning.

In some implementations, the controller 54 may determine to perform debugging operations using the auxiliary processor 52. The controller 54 may output a debug mode entry signal to the auxiliary processor 52 when the core 53 malfunctions. The auxiliary processor 52 may perform a debugging operation according to the debug code based on the debug mode entry signal. This has the advantage that the processor 50 may perform debugging operations at any time according to the request of the debugger 40, regardless of the state of the core 53.

In some implementations, the controller 54 may check whether the core 53 is malfunctioning. The controller 54 may check whether the core 53 is malfunctioning and determine that the core 53 is operating normally. For example, the controller 54 may determine that the core 53 is operating normally based on the state of the program counter within the processor 50.

In some implementations, the controller 54 may determine to perform a debugging operation using the core 53. The controller 54 may output a debug mode entry signal to the core 53 when the core 53 is operating normally. The core 53 may perform debugging operations according to debug code based on a debug mode entry signal. That is, the controller 54 may check the status of the core 53 and determine the subject of the debugging operation based on the status of the core 53.

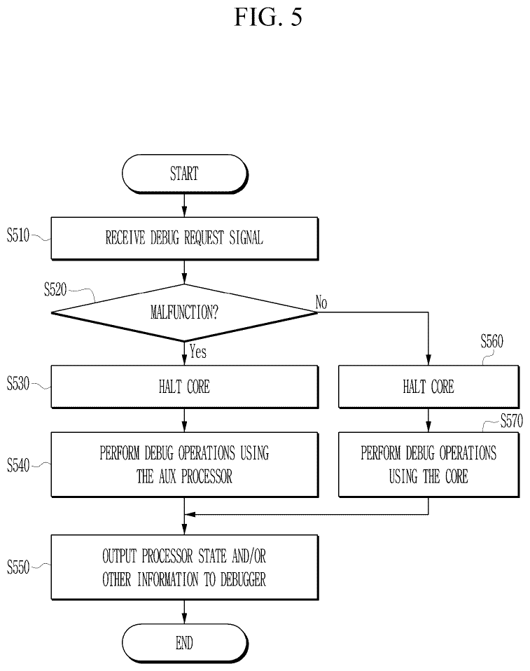

FIG. 5 is a flowchart showing an operation method of a debug circuit according to some implementations.

In some implementations, the debug circuit may receive a debug request signal from a debugger S510. The debugger may output debug request signals at regular intervals or to check the state of the processor.

In some implementations, the debug circuit may check whether the core is malfunctioning S520. The core may malfunction or halt for various reasons while processing the plurality of instructions and data according to the user program. The debug circuit may detect core malfunctions in a variety of ways. For example, the debug circuit may determine whether the core is malfunctioning by checking the state of the program counter for a predetermined period of time, but is not limited thereto. The debug circuit may determine that the core is malfunctioning based on the state of the program counter.

In some implementations, the debug circuit may halt the operation of the core S530. Specifically, the debug circuit may output a halt signal to halt the operation of the core, and the core may halt the operation according to the currently executing program based on the halt signal.

In some implementations, the debug circuit may perform debugging operations using an auxiliary processor S540. Specifically, the debug circuit may output a debug mode entry signal that instructs the auxiliary processor within the debug circuit to enter a debug mode, and perform a debugging operation using the auxiliary processor. The auxiliary processor may perform debugging operations based on debug code stored in debug memory. For example, the auxiliary processor may access control status registers within the processor to gather the state of the processor.

In some implementations, the debug circuit may output processor status and/or other information to a debugger S550. Specifically, the auxiliary processor may obtain processor status data or data stored in other memories according to the debug code. The auxiliary processor may store data acquired according to the debug code in a control status register within the processor or a buffer within the debug circuit. The debug circuit may output data stored in a control status register or a buffer within the debug circuit to the debugger as debug results.

In some implementations, the debug circuit may check whether the core is malfunctioning S520. The debug circuit may check for core malfunctions in a variety of ways and determine that the core is operating normally.

In some implementations, the debug circuit may halt the operation of the core S560. Specifically, the debug circuit may output a halt signal to halt the operation of the core, and the core may halt the operation according to the currently executing program based on the halt signal. The core may halt the currently running program and store information about the program that was running just before the halt in internal registers. After the debugging operation is complete, the core may resume execution of the program from the point where it was halted based on information stored in internal registers.

In some implementations, the debug circuit may perform debugging operations using the core S570. Specifically, the debug circuit may output a debug mode entry signal that instructs the core to enter a debug mode, and may perform debugging operations using the core. The core may perform debugging operations based on debug code stored in debug memory. For example, a core may access control status registers within the processor to gather the state of the processor.

In some implementations, the debug circuit may output processor status and/or other information to a debugger S550.

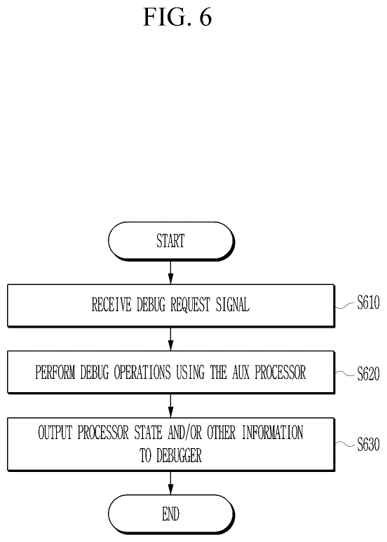

FIG. 6 is a flowchart showing an operation method of a debug circuit according to some implementations.

In some implementations, the debug circuit may receive a debug request signal from a debugger S610.

In some implementations, the debug circuit may perform debugging operations using an auxiliary processor S620. Specifically, the debug circuit may output a debug mode entry signal that instructs the auxiliary processor within the debug circuit to enter a debug mode, and perform a debugging operation using the auxiliary processor. The auxiliary processor may perform debugging operations based on debug code stored in debug memory.

In some implementations, the debug circuit may output the status and/or other information of the processor to the debugger S630.

As described above, the debug circuit according to some implementations may perform debugging operations using the auxiliary processor without checking whether the core is malfunctioning. Additionally, a debug circuit according to some implementations may perform debugging operations using the auxiliary processor without halting the operation currently being performed by the core. This allows the debugging system to perform debugging operations using the auxiliary processor while the core is executing a user program (e.g., regular code).

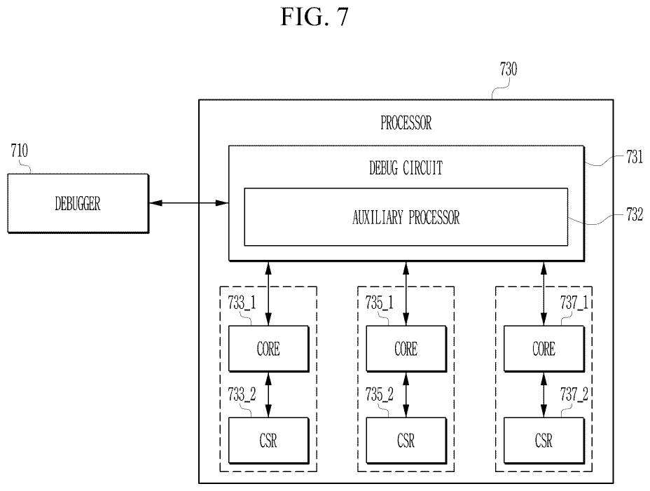

FIG. 7 is a block diagram illustrating a debugging system according to some implementations.

In some implementations, the debugging system 700 may include a debugger 710 and a processor 730.

In some implementations, the processor 730 may include a debug circuit 731 and the plurality of cores 733_1, 735_1, 737_1. The processor 730 may include a plurality of control status registers 733_2, 735_2, 737_2 corresponding to each of the plurality of cores 733_1, 735_1, 737_1. A plurality of control status registers 733_2, 735_2, 737_2 may store and manage the status of the corresponding core 733_1, 735_1, 737_1, respectively. For example, the first control status register 733_2 may store and manage the status of the first core 733_1, the second control status register 735_2 may store and manage the status of the second core 735_1, and the third control status register 737_2 may store and manage the status of the third core 737_1.

In some implementations, the processor 730 may include debug circuitry 731. The debug circuit 731 may be connected to each of the plurality of cores 733_1, 735_1, 737_1. The debug circuit 731 may perform a debugging operation for each of the plurality of cores 733_1, 735_1, 737_1 based on a debugging request signal of the debugger 710.

The debugger 710 may independently request debugging operations for each of the plurality of cores 733_1, 735_1, 737_1. Specifically, the debugger 710 may output a debugging request signal for the first core 733_1 to the debug circuit 731 to obtain the status of the first core 733_1, or may output a debugging request signal for the second core 735_1 to the debug circuit 731 to obtain the status of the second core 735_1.

In some implementations, the debug circuit 731 may independently control each of the plurality of cores 733_1, 735_1, 737_1. Specifically, when the debug circuit 731 receives a debugging request signal for the first core 733_1, the debug circuit 731 may halt the operation of the first core 733_1. For example, when the debug circuit 731 receives a debugging request signal for the first core 733_1, it may output a halt signal to the first core 733_1 to halt the operation of the first core 733_1, and the first core 733_1 may halt the operation according to the currently executing program based on the halt signal. Additionally, when the debug circuit 731 receives a debugging request signal for the first core 733_1, the debug circuit 731 may check whether the first core 733_1 is malfunctioning. For example, when the debug circuit 731 receives a debugging request signal for the first core 733_1, it may determine whether the first core 733_1 malfunctions based on the value of the program counter of the first core 733_1. The above description may be equally applied to the second core 735_1 and the third core 737_1.

In some implementations, the debug circuit 731 may include an auxiliary processor 732. The debug circuit 731 may determine the subject to perform the debugging operation depending on the status of the plurality of cores 733_1, 735_1, 737_1. For example, when the debug circuit 731 receives a debugging request signal for the first core 733_1, it may check whether the first core 733_1 is malfunctioning and determine that the first core 733_1 is malfunctioning. Based on this, the debug circuit 731 may output a halt signal to the first core 733_1 and a debug mode entry signal to the auxiliary processor 732. Based on this, the auxiliary processor 732 may access the first control status register 733_2. In addition, when the debug circuit 731 receives a debugging request signal for the second core 735_1, it may check whether the second core 735_1 is malfunctioning and determine that the second core 735_1 is operating normally. Based on this, the debug circuit 731 may output a halt signal to the second core 735_1 and a debug mode entry signal to the second core 735_1. Based on this, the second core 735_1 may access the second control status register 735_2.

In some implementations, the debug circuit 731 may perform debugging operations according to debug code using the auxiliary processor 732 regardless of the state of the plurality of cores 733_1, 735_1, 737_1. For example, when the debug circuit 731 receives a debugging request signal for the first core 733_1, it may output a halt signal to the first core 733_1 and output a debug mode entry signal to the auxiliary processor 732. Based on this, the auxiliary processor 732 may access the first control status register 733_2. Alternatively, when the debug circuit 731 receives a debugging request signal for the second core 735_1, it may output a halt signal to the second core 735_1 and output a debug mode entry signal to the auxiliary processor 732. Based on this, the auxiliary processor 732 may access the second control status register 735_2.

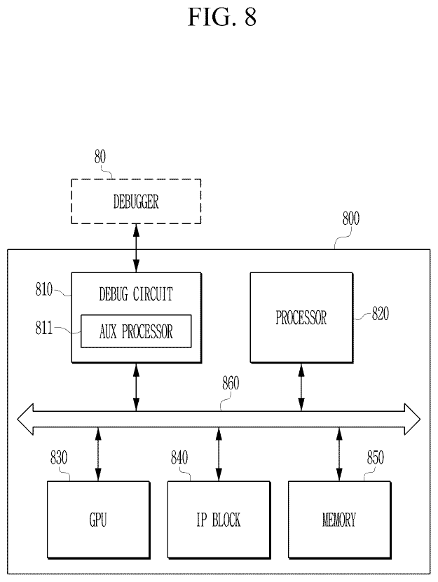

FIG. 8 is a block diagram showing the configuration of a system on chip according to some implementations of the present invention.

Referring to FIG. 8, a system on chip SoC 800 according to some implementations of the present invention may include a debug circuit 810, a processor 820, a Graphic Processing Unit (GPU) 830, an IP block 840, and a memory 850. Each component may be interconnected via a bus 860. The IP block 840 may include at least one IP (master IP, slave IP). The configuration of the system on chip 800 illustrated in FIG. 8 is merely exemplary, and depending on the implementation, the system on chip 800 may include more components or may not include some components.

In some implementations, the processor 820 may include at least one CPU capable of processing or executing programs and/or data stored in a storage device, such as memory 850. The system on chip 800 may include various SoC components, including at least one IP block 840, such as an Application-Specific Instruction set Processor ASIP. The system on chip 800 may be equipped with the plurality of processors that perform various functions, and the processor 820 illustrated in FIG. 8 may play a role in controlling the entire system on chip 800.

In some implementations, the processor 820 may include at least one cluster, each cluster comprising the plurality of CPU cores. The CPU cores may process the plurality of instructions and data that make up software. For example, CPU cores may fetch the plurality of instructions or data, process the fetched instructions or data, and store them in internal registers.

In some implementations, the memory 850 serves as a storage medium for storing data, and may store an operating system OS, various programs, and/or various data. The memory 850 may be implemented as, for example, DRAM or SRAM, but is not limited thereto. For example, the memory 850 may be a nonvolatile memory device (e.g., flash memory, phase change RAM (PRAM), magnetic RAM MRAM, resistive RAM RRAM, or FeRAM device).

In some implementations, the IP block 840 is a component that performs various functions used in the system on chip 800, which may be divided into slave IPs and master IPs, but generally, master IPs may be slave IPs at the same time. The IP block 840 may be a DMA, an audio controller, and a display controller as a master IP, and may be a Universal Asynchronous Receiver/Transmitter (UART), a Timer, an I2C controller, and a Serial Peripheral Interface (SPI) controller as a slave IP.

In some implementations, the debug circuit 810 may be configured to examine the status of CPU cores within the processor 820 according to the request of the debugger 80. The debug circuit 810 may include an auxiliary processor 811 to perform debugging operations according to the request of the debugger 80. Here, the debug circuit 810 may correspond to the debug circuit described with reference to FIG. 1 to FIG. 7. In some implementations, the auxiliary processor 811 may access internal registers of the processor 820 or access memory 850 via the bus 860 according to debugging code corresponding to the debugging operation. The auxiliary processor 811 may obtain data stored in an internal register of the processor 820 or store data in an internal register of the processor 820 according to a debugging code corresponding to a debugging operation. Alternatively, the auxiliary processor 811 may obtain data stored in the memory 850 or store data in the memory 850 according to debugging code corresponding to the debugging operation.

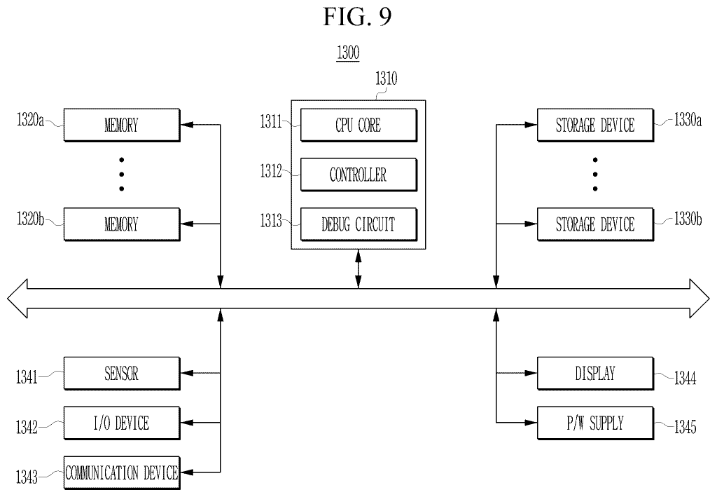

FIG. 9 is a diagram illustrating an electronic system according to some implementations.

The system 1300 may include a main processor 1310, a memory 1320a, 1320b, and a storage device 1330a, 1330b, and may further include a sensor 1341, an input/output device I/O DEVICE 1342, a communication device 1343, a display 1344, and a power supply device P/W SUPPLY 1345.

The main processor 1310 may control the overall operation of the system 1300, more specifically, the operation of other components that make up the system 1300. Such a main processor 1310 may be implemented as a general-purpose processor, a dedicated processor, or an application processor.

The main processor 1310 may include one or more CPU cores 1311 and may further include a controller 1312 for controlling memory 1320a, 1320b and/or storage devices 1330a, 1330b.

In some implementations, the main processor 1310 may include debug circuit 1313. The debug circuit 1313 may obtain the status of the main processor 1310 or the status of other components within the system 1300 at the request of an external debugger. The debug circuit 1313 may further include an auxiliary processor. The debug circuit 1313 may perform debugging operations on the main processor 1310 and other components using an auxiliary processor within the debug circuit 1313 depending on the state of the CPU core 1311. The debug circuit 1313 may correspond to the debug circuit described with reference to FIG. 1 to FIG. 7. The debug circuit 1313 may operate based on the operation method described with reference to FIG. 1 to FIG. 7.

The memory 1320a, 1320b may be used as a main memory device of the system 1300 and may include volatile memory such as SRAM and/or DRAM, but may also include non-volatile memory such as flash memory, PRAM and/or RRAM. The memory 1320a, 1320b may also be implemented within the same package as the main processor 1310.

The storage device 1330a, 1330b may be included in the system 1300 physically separated from the main processor 1310, or may be implemented within the same package as the main processor 1310. Additionally, the storage device 1330a, 1330b may have a form such as a solid state device SSD or a memory card. Such storage devices 1330a, 1330b may be devices to which standard specifications such as Universal Flash Storage (UFS), embedded multi-media card (eMMC), or non-volatile memory express (NVMe) are applied, but are not necessarily limited thereto.

The sensor 1341 may detect various types of physical quantities that may be obtained from outside the system 1300 and convert the detected physical quantities into electrical signals. Such sensors 1341 may be temperature sensors, pressure sensors, light sensors, position sensors, acceleration sensors, biosensors, and/or gyroscope sensors.

The input/output device 1342 may receive various types of data input from a user of the system 1300 and may be a touch pad, a key pad, a keyboard, a mouse, and/or a microphone.

The communication device 1343 may transmit and receive signals between other devices outside the system 1300 according to various communication protocols. Such a communication device 1343 may be implemented including an antenna, a transceiver, and/or a modem.

The display 1344 may function as an output device that outputs visual information to a user of the system 1300.

The power supply device 1345 may appropriately convert power supplied from a battery (not shown) built into the system 1300 and/or an external power source and supply it to each component of the system 1300. While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although the implementations of the present invention have been described in detail above, the scope of the present invention is not limited thereto, and various modifications and improvements made by those skilled in the art using the basic concept of the present invention defined in the following claims also fall within the scope of the present invention.

What is claimed is:

1. A processor comprising:
a core;
a register; and
a debug circuit configured to:
receive a debugging request signal,
determine, based on the debugging request signal, a component to perform a debugging operation, wherein the component is determined as one of the core, an auxiliary processor, or other debug execution component, and
output a debug mode entry signal to the component.

2. The processor of claim 1, wherein the register is configured to store status data indicating a status of the core, and
wherein the debug circuit comprises:
a controller configured to (i) halt an operation of the core based on the debugging request signal and (ii) generate the debug mode entry signal,
a debug memory configured to store debug code corresponding to the debugging operation, and
the auxiliary processor configured to (i) receive the debug mode entry signal from the controller, (ii) access the register based on the debug mode entry signal, and (iii) process the status data based on a debug code.

3. The processor of claim 2, wherein the controller is configured to:
determine an operational state of the core; and
determine the component to perform the debugging operation based on whether the core being in a normal operating state or operating outside of the normal operating state.

4. The processor of claim 3, further comprising:
a program counter configured to store addresses of instructions to be executed by the core,
wherein the controller is configured to determine, based on a value of the program counter being constant for a predetermined time, that the core is operating outside of the normal operating state.

5. The processor of claim 3, wherein the controller is configured to output, based on the core operating outside of the normal operating state, the debug mode entry signal to the auxiliary processor.

6. The processor of claim 5, wherein the core operating outside of the normal operating state includes the core being in a hang state.

7. The processor of claim 3, wherein the controller is configured to output, based on the core being in the normal operating state, the debug mode entry signal to the core.

8. The processor of claim 7, wherein the core is configured to (i) access the register based on the debug mode entry signal and (ii) process the status data based on the debug code.

9. The processor of claim 2, wherein the auxiliary processor is configured to execute instructions based on the debug code.

10. An operating method of processor, comprising:
receiving a debugging request signal indicative of an instruction for determining an operating status of a first core;
determining the operating status of the first core; and
instructing, based on the operating state of the first core, the first core or a second core to perform a debugging operation.

11. The operating method of processor of claim 10, wherein determining the operating status of the first core comprises:
determining a status of a program counter that is configured to store addresses of instructions to be executed by the first core.

12. The operating method of processor of claim 11, comprising:
determining that the first core is operating outside a normal operating state based on a value of the program counter being constant for a predetermined time.

13. The operating method of processor of claim 10, wherein instructing the first core or the second core to perform a debugging operation comprises:
determining that the first core is in a normal operating state;
halting the operation of the first core; and
outputting a signal to the first core, wherein the signal is indicative of an instruction to perform the debugging operation.

14. The operating method of processor of claim 10, wherein instructing the first core or the second core to perform the debugging operation comprises:
determining that the first core is operating outside a normal operating state;
halting the operation of the first core; and
outputting a signal to the second core, wherein the signal is indicative of an instruction to perform the debugging operation.

15. The operating method of processor of claim 14, comprising:
obtaining status data from the second core, wherein the status data represents a status of the first core and is stored in a register; and
outputting, to a debugger, the status data as a debugging result.

16. The operating method of processor of claim 14, wherein:
the first core operating outside the normal operating state includes the first core being in a hang state.

17. A system on chip, comprising:
a memory,
a processor comprising a core configured to process data stored in the memory, and
a debug circuit configured to
halt an operation of the core based on a debugging request signal,
determine, based on a state of a program counter of the processor, an operating state of the core, and
perform, based on the operating state of the core and a debug code, a debugging operation.

18. The system on chip of claim 17, wherein the debug circuit comprises:
a controller configured to output, based on the debugging request signal, a halt signal to the core and halt the operation of the core;
a debug memory configured to store the debug code; and
an auxiliary processor configured to perform, based on the debug code, the debugging operation.

19. The system on chip of claim 18, wherein the controller is configured to:
determine the core being in a hang state based on the state of the program counter; and
control the auxiliary processor to access the debug memory based on the debug code.

20. The system on chip of claim 19, wherein the debug circuit is configured to output, based on the debug code, data obtained by the auxiliary processor, to a debugger as a debug result.
